(19) United States
(12) Patent Application Publication
(10) Pub. No.: US 2004/0030640 A1
(43) Pub. Date: Feb. 12, 2004

(54) System and method for online leasing

(75) Inventors: Tracy A. Mahnken, San Bruno, CA (US); Pamela D. Weiss, Palo Alto, CA (US); Benjamin C. Graboske, Newbury Park, CA (US); Patrick R. Whelan, Westlake Village, CA (US)

Correspondence Address: STINSON MORRISON HECKER LLP, ATTN: PATENT GROUP, 1201 WALNUT STREET, SUITE 2800, KANSAS CITY, MO, 64106-2150, US

(73) Assignee: Homestore.com, Inc.

(21) Appl. No.: 09/843,904

(22) Filed: Apr. 27, 2001

(51) Int. Cl. G06F 17/60

(52) U.S. Cl. 705/39

(57) ABSTRACT

The present invention provides an online leasing system. The system allows a consumer to view availability listings for currently vacant units and those units that have been forecast as vacant. The system accepts consumer demographic data and performs a pre-lease screening process to determine the suitability of the consumer. Suitable consumers are allowed to enter into a leasing agreement while online or reserve the unit for future leasing. Payment of the required deposit and any other monies due are processed as electronic payments. Ancillary electronic commerce services can also be integrated into the system for the convenience of the consumer.

### BACKGROUND OF THE INVENTION

1. Field of the Invention

The present invention generally relates to the leasing of commercial or residential property and more specifically relates to executing a lease agreement for commercial or residential property over a computer network.

2. Related Art

Conventional systems and methods for leasing space employ the vast resources of computers and computer networks to merely provide floor plans, photographs, descriptions, and other informational to interested parties. Typically, the information is presented to interested parties in combinations of text and graphics. For example, a description of an apartment may include a written description of the floor plan, a description of the available amenities and services offered by the complex and a photograph of the community club house. In some cases, photographs of the actual unit may be available and presented to interested parties.

These conventional systems lack the ability to complete a leasing transaction completely online. Although sufficient information can be presented to an interested party, the actual leasing steps are typically carried out in person between a leasing agent and the interested party. Possibly, the leasing steps can be carried out over the telephone, however this still requires one to one communication between the leasing agent and the interested party. Therefore, what is needed is a system and method that overcomes these significant problems found in the conventional systems as described above.

### SUMMARY OF THE INVENTION

The present invention provides a system and method for executing a lease agreement over a computer network. The online leasing system allows a consumer to view a listing of currently available units and also those units that have been forecast as vacant. Advantageously, the consumer can view the floor plan for each available unit in addition to the rent, deposit, and fee information for each available unit.

The system accepts demographic data pertaining to the consumer and performs a pre-lease screening process to determine the desirability of the consumer. Suitable consumers are allowed to enter into a leasing agreement while online or reserve the unit for future leasing. Additionally, the amount of the security deposit can be determined based on the demographic data or by standards or criteria established by a property manager.

Payment of the required security deposit and any other monies due, such as the first month's rent, are processed as electronic payments. Future rent payments can be billed to the consumer through the system and the payments an also be electronically processed through the system. Ancillary electronic commerce services can also be integrated into the system for the convenience of the consumer, such as online billing, record keeping, account maintenance, and online payments.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is block diagram illustrating an overview of an example architecture for a system for establishing leases over a computer network, according to an embodiment of the present invention;

FIG. 2 is a block diagram illustrating an example server architecture for a system for establishing leases over a computer network, according to an embodiment of the present invention;

FIG. 3 is a block diagram illustrating an example interface architecture for a system for establishing leases over a computer network, according to an embodiment of the present invention;

FIG. 4 is a flow chart illustrating an example process for initiating a lease over a computer network, according to an embodiment of the present invention;

FIG. 5 is a flow chart illustrating an example process for initiating a joint application lease over a computer network, according to an embodiment of the present invention;

FIG. 6 is a flow chart illustrating an example process for confirming a lease and providing payment over a computer network, according to an embodiment of the present invention;

FIG. 7 is a flow chart illustrating an example process for confirming a joint application lease and providing payment over a computer network, according to an embodiment of the present invention;

FIG. 8 is a flow chart illustrating an example process for providing ancillary commercial products and services over a computer network, according to an embodiment of the present invention; and

FIG. 9 is a block diagram illustrating an exemplary computer system as may be used in connection with various embodiments described herein.

### DETAILED DESCRIPTION OF THE INVENTION

Certain embodiments as disclosed herein provide for a system and method for executing a lease agreement over a computer network. For example, one method as disclosed herein allows for an online consumer to view the availability of units, view the rent, deposit, and fees for each available unit, and apply to lease an available unit. The system subsequently processes demographic information about the consumer to determine the suitability of the consumer. If the consumer is suitable, the consumer is presented with a lease for acceptance. Payment of the deposit and any other fees can be processed through an electronic payment module.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

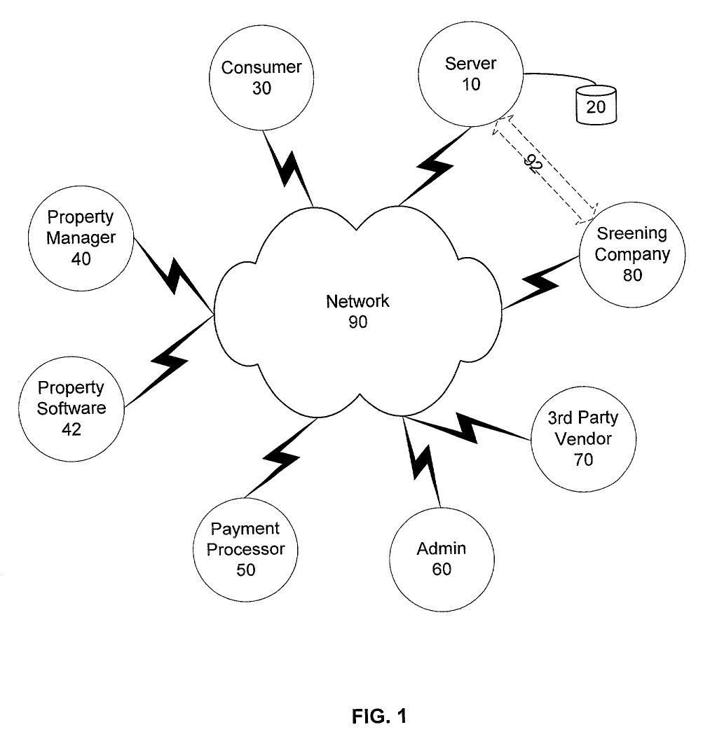

FIG. 1 is block diagram illustrating an overview of an example architecture in a system for establishing leases over a computer network. The system may be comprised of a server 10 that is configured with a database 20. Additionally, the system may comprise one or more consumers 30, one or more property managers 40, one or more property management software installations 42, one or more payment processors 50, one or more administrators 60, one or more third party vendors 70, and one or more screening companies 90. Preferably, each component of the system is communicatively coupled through a network 90.

In one embodiment, server 10 may be communicatively coupled with screening company 80 through a secure connection 92. Furthermore, server 10 may be communicatively coupled with any other component of the system such as third party vendor 70 and payment processor 50 through a secure connection (not shown). Advantageously, a secure connection may provide for the secure transmission of sensitive data such as financial information and the like.

Database 20 may be comprised of data germane to the operation of a system for establishing a lease over a computer network. Database 20 may contain a plurality of records relating to the various entities that comprise the system and a plurality of real estate properties, each comprised of a plurality of units. For example, database 20 may contain numerous records, each of which describes a particular unit in a rental property such as an apartment complex or business park. Additionally, database 20 may contain a plurality of records, each describing a consumer 30, property manager 40, payment processor 50, administrator 60, vendor 70, or screening company 80. Additional records may also be contained in database 20 that describe other entities or properties as may be helpful in the operation of the system.

Furthermore, database 20 may be optimized to provide efficient collection, storage, and retrieval of data related to establishing leases over a computer network. Database 20 may also be comprised of several logically or physically discrete distributed databases that can be united by a common normalization of the stored data and a common data retrieval scheme. For example, such a distributed scheme for database 20 may advantageously be employed in a system that comprises more than one server 10. In such an embodiment, each discrete server 10 may house a portion of a distributed database that comprises database 20.

Database 20 may be organized as a set of records or as files in a hierarchical file system. For example, database 20 may be populated with a set of records that conform to a commercial database format, such as Oracle® or Microsoft Access®. In one embodiment, the records or files that comprise each discrete entity or property can be located within a single directory in a hierarchical file system. For example, a particular property may be comprised of several hundred units. Therefore, each record or file that describes a unit at that property may be co-located in a single directory. Furthermore, various subdirectories may be employed to more granularly organize the data that comprises the property's listings. Database 20 may also employ a configuration management utility (not shown) to facilitate access to the stored information.

In one embodiment, the list of available properties and units presented to client 20 may be filtered by server 10 based upon certain permissions. For example, client 20 may be required to provide authentication information to server 10 during the connection process. The authentication information may then constrain client 20 to accessing only that data in database 20 for which client 20 has been approved access. Such authentication procedures and access control capabilities (i.e. system logins and permissions) are well known in the art and are therefore not described in detail herein.

An additional function of database 20 can be to store profile information relating to existing consumers 30. The profile information may help to facilitate the consumer's 30 secure access to sensitive data by providing the necessary authentication and permissions structure. For example, consumer 30 may connect to server 10 using a username/password combination that allows server 10 to provide consumer 30 with secure access to property listings, unit availability, pricing information, and vacancy forecasts. Furthermore, consumer 30 may save this information for later retrieval, viewing, and comparison.

Consumer 30 can be any entity that is seeking real estate. Consumer 30 can be an individual, a group, or a business. For example, consumer 30 may be a person, a family, a corporation, a partnership, or some other type of group that is seeking real estate. Preferably, consumer 30 is seeking to lease space for a residential or business purpose. In an alternative embodiment, consumer 30 may be seeking to purchase space.

Furthermore, consumer 30 may or may not be registered with server 10. The role of consumer 30 is that of an entity seeking real estate. Consumer 30 may interact with server 10 to search through database 20 for desired real estate properties. For example, consumer 30 may save, compare, and map search results from database 20. Furthermore, consumer 30 may review the availability of the properties listed in a search result, view pictures of the properties, review floor plans, and interact with the data and property listings in database 20 in order to find a desirable property.

In one embodiment, consumer 30 may connect to system 10 over network 90 and browse through and query database 20 to find a particular space to rent. The particular space may be a specific floor plan or unit that meets the needs of consumer 30. Preferably, consumer 30 is presented with real time availability status, pricing information, and forecasting of future availability. Consumer 30 may complete a credit application and initiate the rental application and lease process. While connected to server 10 through network 90, consumer 30 may navigate through multiple steps to complete the leasing process.

Furthermore, consumer 30 may pause the process, saving the information entered and then later resume the process at another time. Additionally, consumer 30 may sign up for complementary services and obtain help during the leasing process. For example, consumer 30 may initiate a chat session with a support technician or a customer service professional. In one embodiment, consumer 30 may communicate with property manager 40 or a leasing agent (not shown). For example, consumer 30 may initiate a chat session or send an email to property manager 40 to discuss particular aspects of the lease.

Property manager 40 can be the owner of a single unit or a complex of units that are available for residential or commercial lease. Additionally, property manager 40 can be an agent of the owner, such as a leasing agent, apartment manager, or the like. Property manager 40 preferably oversees the leasing process. For example, property manager 40 may connect to system 10 over network 90 to track the status of units that comprise the property or properties that property manager 40 is responsible for. Property manager 40 may communicate with prospective consumer 30 to answer questions about particular units or the leasing process. In one embodiment, property manager 40 may communicate with a prospective consumer 30 via email.

An additional function of property manager 40 may be to confirm the status of consumer 30 or verify information provided by consumer 30. For example, property manager 40 may contact references provided by consumer 30 to verify that the information provided by consumer 30 is accurate.

Third party property management software installation 42 can be any of the various property management utilities that are commonly used by property managers 40 to manage the property. For example, property management software installation 42 can be an enterprise system, used internally (within the enterprise) by property manager 40. Some example third party property management software installations include Real Page, Realeum, and Yardi, just to name a few.

Payment processor 50 may be a financial institution, clearing house, or other entity that facilitates the transfer of funds between parties. For example, payment process may effect the transfer of a rental application fee from consumer 30 to property manager 40. In one embodiment, payments may be transferred via electronic payment such as online check, a credit card, electronic funds transfer (“EFT”), and automatic clearing house (“ACH”), just to name a few.

Payment processor 50 may further have the ability to process a payment and divide the payment into several appropriate accounts. Additionally, payment processor 50 may provide a tracking service that allows a payment to be traced from the source to the recipient. Furthermore, payment processor 50 may also provide a payment history service that allows a party to review past payments.

Administrator 60 is preferably familiar with the operation of server 10 and facilitates the communication flow and working process of establishing leases online. Administrator 60 may reside with server 10 or be a remote entity. Preferably, administrator 60 can manage the capabilities of server 10 to achieve efficient processing and presentation of the services provided by server 10.

Furthermore, administrator 60 may provide consumer 30 with assistance in the operation of the services available through server 10. In one embodiment, administrator 60 is familiar with the external products and services that are integrated with server 10. For example, administrator 60 may provide external vendors such as payment processor 50, third party vendor 70, and screening company 80 with assistance on how their services integrate with server 10. Additionally, administrator 60 may provide property manager 40 with assistance on setting the unit status (e.g. available, prospectively available, or occupied). Administrator 60 may also provide property manager 40 with assistance on how to use the integrated products and services offered by payment processor 50, third party vendor 70, and screening company 80.

Another function that may be provided by administrator 60 can be management of reporting processes carried out on server 10. For example, each property manager 40 may have a customized report generated by server 10 on a periodic basis. Additionally, advertisers and third party vendors 70 may be sent reports on traffic visiting server 10 or traffic forwarded to third party vendors 70.

Third party vendor 70 may be an electronic commerce provider. Consumers 30 may be forwarded to a third party vendor or server 10 may facilitate a transaction with consumer 30 on behalf of third party vendor 70. In one embodiment, transactions facilitated by server 10 may be sent to third party vendor 70 at the completion of the transaction, or several transactions may be stored and periodically sent to third party vendor 70 in a large batch transmission. For example, a third party vendor 70 may be a moving company, and each request for pricing information can be sent directly to the moving company. Alternatively, a third party vendor 70 may be a department store, and requests to change the consumer's 30 address may be stored until the end of the day and then all such requests may be sent to the third party vendor 70 (department store) in a single transmission.

Screening company 80 may be any of a variety of entities that accept information about a potential tenant and run a report to determine the suitability of the potential tenant. In one embodiment, consumer 30 may provide information to server 10 that is forwarded on to screening company 80. Screening company 80 may then use that information to determine if consumer 30 is a suitable potential tenant. Screening company 80 may also send a report to server 10. The report sent by screening company 80 may be sent in electronic format over network 90 (or secure connection 92). Alternatively, screening company 80 may send a report to server 10 through traditional channels such as U.S. mail.

Network 90 preferably facilitates communication between server 10 and the respective clients 20, 22, and 24. Additionally, network 90 may facilitate communication between server 10 and any additional client(s) that comprise the system. In alternative embodiments, network 90 may be a proprietary network, a public network, a wide area network (“WAN”), a local area network (“LAN”), or a combination of networks, such as the well known Internet. Additionally, network 90 may be a wired network or a wireless network.

Network 90 preferably supports a variety of communication protocols such as TCP/IP, UDP, HTTP, FTP, SMTP, POP and the like. In one embodiment, communications between server 10 and the various clients may use the World Wide Web (“WWW”) service that employs the HTTP communication protocol. For example, consumer 30 may establish an HTTP connection with server 10 using the WWW service. Server 10 may then use the HTTP protocol to provide information requested by consumer 30 through the WWW service.

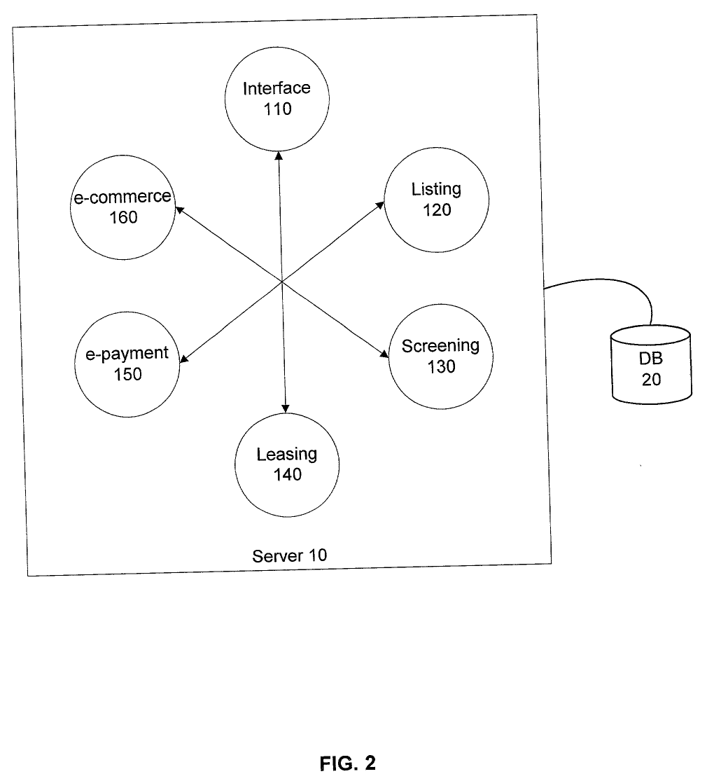

FIG. 2 is a block diagram illustrating an example architecture for server 10 in a system for establishing leases over a computer network. Server 10 is comprised of an interface module 110, a listing module 120, a screening module 130, a leasing module 140, an electronic payment module 150, and an electronic commerce module 160. Additionally, server 10 can preferably be communicatively coupled with a database 20.

Interface module 110 may advantageously be configured to facilitate communication with a variety of entities that interact with server 10. For example, interface 110 may facilitate communication with consumer 30, property manager 40, and admin 60. Interface 110 may also facilitate communication between server 10 and payment processor 50, third party vendor 70, and screening company 80.

Listing module 120 advantageously provides information to prospective residents regarding the availability of units and the pricing of the units. The information content provided by listing module 20 may come from database 20, a third party property management software installation (not shown), or both. For example, listing module 120 may provide a listing of units that are currently available. Additionally, listing module 120 may provide a listing of units that are prospectively available, and preferably the date that the unit will become available. In one embodiment, the future availability information may include forecasts for unit availability broken down into 30 day, 60 day, and 90 day forecasts.

The information provided may include a visual diagram of the floorplan for the unit, photographs, sketches, artists renditions or other types of visual media portraying the inside of the unit, the view from the unit, or other desirable visual images that are helpful to prospective residents. For example, the information regarding the available unit may describe the unit as having a certain number of bedrooms, and also include a picture of each bedroom. Furthermore, the unit may be described as having a view of the pool and a picture of that view from the unit may be provided. Additionally, the information provided by listing module 120 may be updated such that inquiries made by potential residents are provided with real time up-to-date information.

For example, a potential resident may connect to server 10 through a network. The potential resident may have a particular unit in mind or may desire to search for available space. Advantageously, server 10 may allow the potential resident to search through data stored in database 20 until the potential resident locates the desired unit. Alternatively, server 10 may allow the potential resident to search through data obtained from third party property management software installations.

In one embodiment, a search may include criteria such as geographic region, zip code, address, property name, location name (e.g. the name of a college or university), and the like. Additional criteria may also be provided, such as the number of bedrooms, number of bathrooms, air conditioning, cable, in unit laundry, work out facility, and other amenities provided by the community or complex.

Search results may also be filtered in a variety of ways to present the results in the most efficient manner. For example, the results may be filtered by price, distance from a particular location, or other germane factors. The results may also be filtered by availability, such as those units immediately available and those units available within 30 days. In one embodiment, a potential resident may save particular listings for later comparison against other listings or later distribution to other potential residents such as a roommate. Such distribution can preferably take place via electronic mail.

In one embodiment, when a potential resident saves a search result, the information is stored in database 20 and associated with the particular potential resident. If the potential resident is accessing server 10 in an anonymous manner, the potential resident may advantageously be allowed to register with the server 10 so that the search result may be stored with the potential resident's new user profile.

The potential resident may then browse through the results and select any unit for further information and viewing. The potential resident may be able to see the availability of the unit, read a description of the unit, see a floor plan of the unit, view a photo of the unit, and use a 360 degree viewer to browse the unit. The potential resident may also be provided with directions to the location of the unit, and view information and statistics regarding the location of the unit, such as weather information and crime statistics. A property management company may also provide contact information of current and past residents as a reference.

Listing module 120 may also allow a property manager to update and maintain the listing data, including location, pricing, and availability information. Additionally, listing module 120 may allow a property manager to update any visual images associated with a unit or complex, such as floor plans, photos of the units, and photos of the views from the units. In one embodiment, listing module 120 may also allow a property manager to upload listing information and data to the server 10.

Screening module 130 preferably allows an authenticated prospective resident to be evaluated or scored in order to determine the suitability of the prospective resident as a tenant. In one embodiment, the criteria that defines a suitable prospective resident can be provided by the property management company or by the particular community or the owner of the unit or units.

The evaluation provided by screening module 130 may consider the credit history for the prospective tenant, employment history, education level, criminal background, and salary information among other information. Preferably, all of this information is either provided by the prospective resident, or obtainable by server 10 over a network. In one embodiment, all of the required information can be obtained by server 10 over a network in real time so that the prospective tenant evaluation may be immediately completed.

For example, prior to approving a prospective resident, the prospective resident can register with server 10 and provide certain application information. Once the prospective resident has selected an available unit and a move in date, the application information (e.g. social security number), can be sent by screening module 130 to an external screening company. The external screening company may then obtain the prospective resident's credit, employment, criminal, and educational history for analysis. In one embodiment, the external screening company may evaluate the information and provide screening module 130 with a score for the prospective tenant. Alternatively, the external screening company may provide screening module 130 with the acquired information for scoring by screening module 130 according to the appropriate criteria, such as the criteria provided by the property management company.

Additionally, payment information may be required from the prospective resident in order to cover any costs associated with screening the prospective resident's application. Furthermore, screening module 130 may provide the appropriate screening criteria to the external screening company for analysis. Advantageously, this may allow the external screening company to provide screening module 130 with an acceptance level for the prospective client.

For example, the external screening company may provide screening module 130 with one of three levels of suitability for the prospective client, such as (1) approved; (2) approved with exception; and (3) denied. In one embodiment, screening module 130 may immediately process any prospective tenant's application that returns either an approved or denied result from the external screening company. Screens that result in a denial can be denied while screens that result in an approval can be further processed. For example, a notification may be sent to the prospective client explaining the reasons for the denial. Advantageously, this type of notification may be sent via email and include the necessary information to comply with any regulations that apply to credit denials. Additionally, screening module 130 may contact a third party credit provider to help determine the suitability of the prospective tenant.

Leasing module 140 can provide a prospective resident the ability to generate a completed rental application while connected to server 10 over a network. A completed rental application may comprise a lease agreement, legal compliance forms, maintenance forms, and other forms and applications helpful to provide sufficient information to a property manager so that a leasing decision can be made.

For example, a prospective resident (referred to as consumer 30 in FIG. 1) may connect to server 10 and fill out the requisite application forms. If the prospective resident is not registered with the server 10, the prospective resident can advantageously establish a user profile prior to submitting an application. Leasing module 140 can present to a registered prospective resident a lease form or a rental application. The prospective resident can then provide the application information. Leasing module 140 preferably presents the application form in an efficient, easy to use fashion, and elicits the information necessary to generate a completed application with all of the lease terms, addenda, and rules and regulations desired by the property management company.

Leasing module 140 can present the completed lease agreement to the prospective resident for review once the necessary information has been collected. Included in the information presented for review can be the lease agreement, addenda, community rules and regulations, and other information deemed appropriate by the property management company.

In one embodiment, an object of leasing module 140 can be to accept a legally binding signature from the prospective resident. For example, leasing module 140 may accept a signature from the prospective resident using digital signature methods. Additional methods of accepting a signature from the prospective resident will be apparent to those having skill in the art and will therefore not be discussed in detail herein.

Leasing module 140 an additionally allow the prospective resident to pause or stop the application process at any time during the process. Preferably, when a prospective resident pauses or stops the process, leasing module 140 can save the partially completed application in database 20 and associate the partially completed application with the user profile of the prospective resident.

Advantageously, a saved application can be later accessed by the prospective resident to save time and streamline the application process. In one embodiment, a requested unit may be held by leasing module 140 so that the prospective resident can return to the application within a reasonable period of time to complete the application for the particular unit. In one embodiment, if the prospective resident does not complete the application with the reasonable period of time, the held unit can be released and the prospective resident may forfeit the application fee.

In an alternative embodiment, a prospective resident may be able to modify the lease within certain pre-established parameters. For example, the prospective resident may elect to sign a 6 month lease or a 12 month lease. Such variable parameters may be pre-established by the property management company and stored in database 20 so that the prospective resident feels empowered in establishing a “personalized” lease. Additional lease conditions and clauses can have variable terms as desired by the property management company. Alternatively, the lease terms may be non-negotiable and a prospective resident may be required to accept the terms as presented.

In one embodiment, a prospective resident may partially complete an application and subsequently call on the property management company in person to finish the application. Advantageously, a property management representative, or leasing specialist, may access server 10 and retrieve the partially completed application from database 20. The partially completed application can then be completed.

Alternatively, a prospective resident may initially confer with a property manager and partially complete the application process. The partially completed application can advantageously be saved by the property manager or its representative in database 20. Subsequently, the prospective resident may access server 10 and retrieve the partially completed application for completion while online.

Electronic payment module 150 preferably provides server 10 with the ability to accept and process payments from a prospective resident or an established tenant. This ability to accept and process payments can include the processing of credit card payments, handling and processing of ACH payments, electronic funds transfer (“EFT”), online checks, and automatically debiting a checking account, just to name a few. Examples of the types of payments server 10 may receive include rental application fees, security deposits, payment for electronic commerce transactions, monthly rent, cable TV payments, utility company payments, phone company payments, and other related fees and transaction costs.

In one embodiment, payments processed by electronic payment module 150 are immediately reported to the consumer or potential resident. For example, a status message may be presented to the consumer or potential resident to provide notice that the transaction has been either approved or disapproved. Furthermore, after successful payment has been made through electronic payment module 150, the consumer or prospective resident can preferably be presented with a receipt or transaction record.

Electronic payment module 150 may also send electronic payments to a third party payment processor for handling and processing. In such an embodiment, the third party processor preferably completes the transaction and immediately notifies electronic payment module 150 of the status of the transaction. Electronic payment module 150 can subsequently inform the consumer or prospective resident of the status of the transaction and provide a receipt where appropriate.

Electronic commerce module 160 can provide modular extensions to the services offered by server 10. For example, ancillary revenue generating services can be added into the suite of products and services managed by electronic commerce module 160. In one embodiment, moving services from third party moving companies can be integrated into server 10 through electronic commerce module 160.

The modular services managed by electronic commerce module 160 can be informational or transactional. For example, informational services may be a yellow page listing or online stock quotes. Transactional services may include those services that allow for the purchase of desired goods or services, such as buying a new couch, scheduling movers, or purchasing storage space. Additionally, the modular services managed by electronic commerce module 160 may include setting up the telephone, cable TV, Internet connectivity, long distance telephone, and various other services for a new residence.

Advantageously, electronic commerce module 160 can host the various point-of-lease ancillary e-commerce products and services or electronic commerce module 160 can frame the e-commerce services offered by another entity. For example, certain vendors may require more information than is stored in database 20. Such transactions may be passed off to the third party vendor within a frame so that the transition to the vendor and return to server 10 is seamless to the consumer. For example, the external frameset may display the logo of server 10 while the internal transaction screens are generated by the third party vendor.

In one embodiment, once a prospective resident/consumer has paid a deposit, the consumer may be presented with a variety of e-commerce services that can simplify the moving process. For example, the consumer may elect to be contacted by a moving coordinator or moving concierge that can manage the moving process for the consumer.

Preferably, electronic commerce module 160 can provide services that allow the consumer to rent furniture, fill out a change of address form, sign up for a local gym membership, and turn on the utilities in the new unit. In one embodiment, the products and services hosted by or integrated into electronic commerce module 160 can be selected by the property management company. Advantageously, this may allow the property management company to establish preferred vendor relationships that reduce costs to the consumer and increase revenues to the property management company.

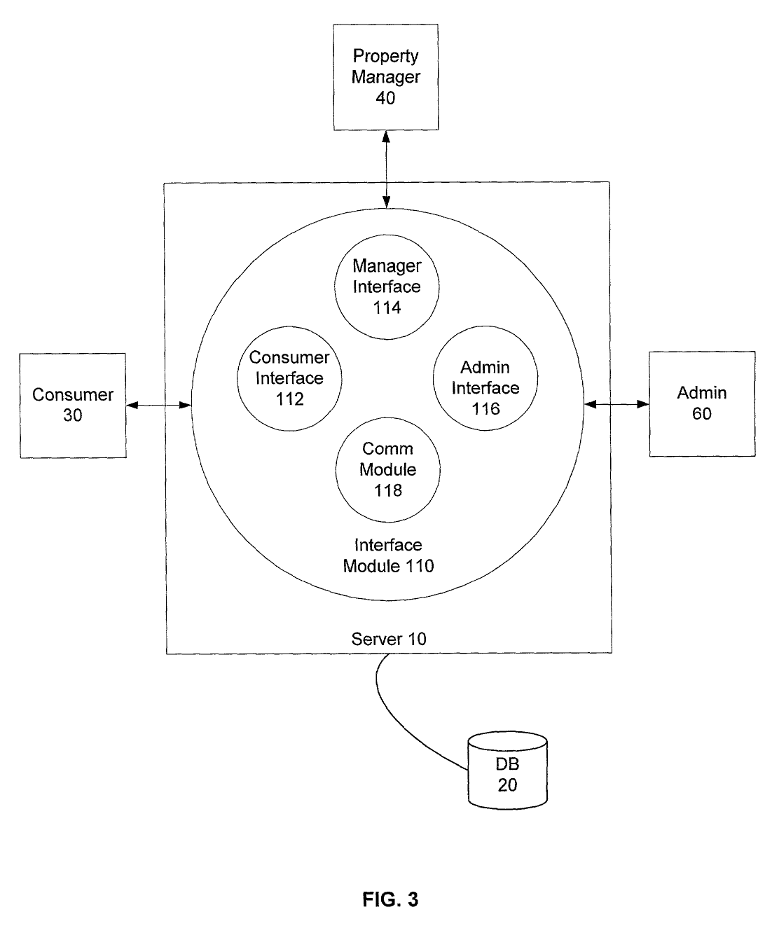

FIG. 3 is a block diagram illustrating an example interface module 110 in a system for establishing leases over a computer network. Interface module 110 resides on server 10 of the system and preferably manages the communications between server 10 and the external components of the system. For example, interface module 110 may handle the communication with consumers 30, property managers 40, administrators 50, as well as any payment processors (not shown), third party vendors (not shown), or screening companies (not shown).

In one embodiment, interface module 110 can be comprised of consumer interface 112, property manager interface 114, administrator interface 116, and communication module 118. Preferably, consumer interface 112 can be optimized for communication with consumer 30, property manage interface 114 can be optimized for communication with property manager 40, administrator interface 116 can be optimized for communication with administrator 60, and communication module 118 can be configured for general communications with other entities.

Consumer interface 112 preferably allows a potential resident or consumer 30 to establish a connection with server 10. In one embodiment, consumer interface 112 may include a plurality of pages that display information to consumer 30 and allow consumer 30 to register or sign in with server 10 and interact with the services for establishing a lease over a computer network as provided. For example, consumer interface 112 can provide the ability for consumer 30 to search through the available unit listings maintained in database 20. Additionally, consumer interface 112 can allow consumer 30 to establish a lease, pay a deposit, pay rent, purchase ancillary products or services, and provide information for the rental screening process.

Property manager interface 114 preferably allows property manager 40 to upload new listings data into database 20. Additionally, property manager interface 114 can allow property manager 40 to receive and respond to inquiries from consumer 30. For example, property manager interface 114 may allow property manager 40 to connect to server 10 and provide authentication information, or otherwise login. Furthermore, property manager interface 114 may allow property manager 40 to upload, edit, delete, and modify the data that comprises the listings in database 20. Additionally, property manager interface 114 may allow property manager 40 to provide the criteria that defines a suitable prospective resident in the screening process.

Administrator interface 116 preferably allows administrator 60 to manage the system residing on server 10 for establishing leases over a computer network. Administrator 60 is preferably able to manage authentication information for property managers 40, consumers 30, and other entities that may connect to server 10. Additionally, administrator interface 116 may allow administrator 60 to configure the communication requirements for server 10 to communicate with other entities such as screening companies, third party vendors, payment processors, ancillary service providers, and the like.

Communication module 118 preferably provides a dependent, stable, and ubiquitous channel for server 10 to communicate with entities such as screening companies, third party vendors, payment processors, ancillary service providers, and the like. For example, communication module 118 may allow for server 10 to generically communicate using an electronic mail format. Advantageously, the electronic mail format (or other configured format) is well known and likely implemented in the various types of systems that may be communicating with server 10. In this fashion, server 10 can generically communicate with other types of systems through a generic utility implemented by communication module 118 and common to all systems.

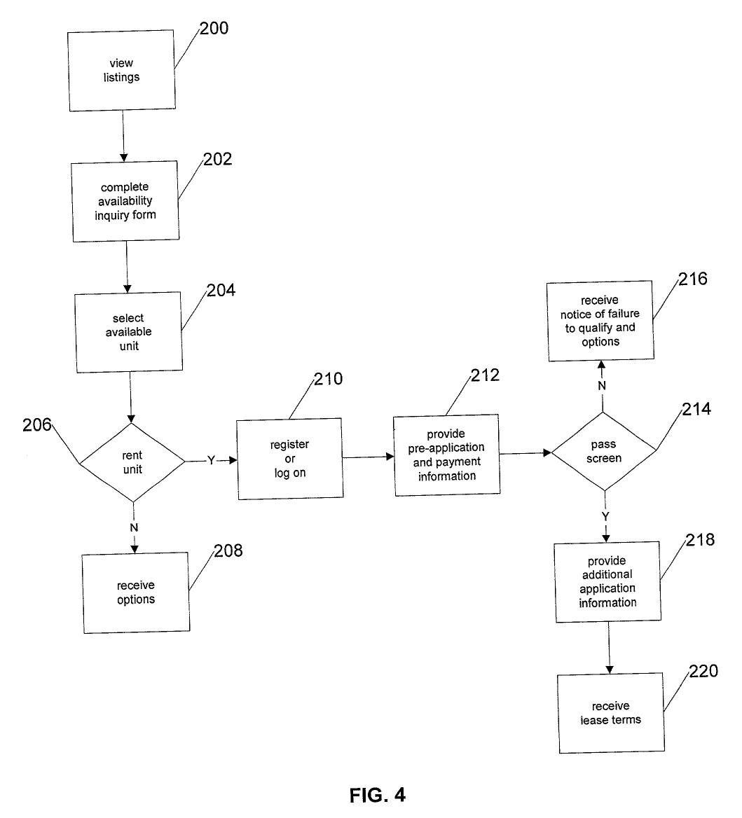

FIG. 4 is a flow chart illustrating an example process for initiating a lease in a system for establishing leases over a computer network. Initially, a consumer can view the listings that are provided by the system, as illustrated in step 200. In one embodiment, a consumer may be required to log into the system prior to being able to view the listings. Alternatively the consumer may be allowed to view the listing without logging into the system or registering with the system.

Furthermore, the listings may comprise those units that are currently available and the monthly rental price for each unit. Preferably, a picture of the inside of the unit may be available. Additionally, a floor plan of the unit may be provided in the listings, along with photographs or drawings of the view from the unit or any other special characteristics that may make the unit desirable to the consumer. The listings can also include a description of the unit, and summary information such as the number of bedrooms, the number of bathrooms, square feet, and other characteristics of the unit.

In an alternative embodiment, listing may be provided that include units that will be available in the future. For example, a listing may be provided that shows units that are prospectively available in 30 days, 60 days, and 90 days. Additionally, prior or current tenant information may be provided in the listing so that a consumer may contact the prior or current tenant as a reference for the unit.

Once the consumer has viewed the listings of available and prospectively available units, the consumer may complete an availability inquiry form, as shown in step 202. This form may request information from the consumer such as whether the consumer owns pets, requires wheelchair or other disability access. Additionally, the availability inquiry form may allow the consumer to provide criteria describing the characteristics of a desired unit. For example, the consumer may provide certain criteria on the form such as the number of bedrooms, number of bathrooms, square feet of the unit, etc.

After the consumer has submitted the form to the system for processing, the consumer can select a unit in step 204 from the resulting list of available units that matched the search criteria. In one embodiment, the consumer can select an available unit from a list of units that includes units that are currently available and units that will become available in the future. If no units are available that match the criteria provided on the availability form, the consumer can be informed of other options and perhaps presented with a list of units that very closely, but not completely match the search request.

Once the consumer has selected an available unit, the consumer decides whether or not to rent the unit, as seen in step 206. If the consumer decides not to rent the unit, then a list of suggested options can be presented to the consumer, as illustrated in step 208. For example, the consumer may be prompted to select another unit or change the desired floor plan. Additionally, the consumer may be presented with a list of available ancillary services or electronic commerce products.

In step 210, after the consumer has affirmatively decided to rent the unit, the consumer may be prompted to log into the server or register with the server as a consumer. Preferably, the registration process elicits the necessary consumer profile and financial background information to establish a record for the consumer. If the consumer is already registered, then the consumer may login to the system, which allows the system to access the consumer profile information from the already established record.

Once the consumer has registered or logged into the system, the consumer is requested to provide additional pre-application information and payment information. Preferably, the additional pre-application information and payment information provided is sufficient to run a background and credit check on the consumer. In one embodiment, after the consumer has provided the additional information, a hold may be placed on the selected unit so that the consumer may interrupt the application process for later completion. For example, the process may be paused for a prescribed period of time, such as 24 hours, at which time the held unit can be released.

The information provided by the consumer in step 212 can preferably be used to screen the consumer to determine the suitability of the consumer for renting the unit. In one embodiment, the server completes the screening process based on criteria established by the property management company. In an alternative embodiment, the consumer data and screening criteria can be provided to a third party screening company that processes the data and determines if the consumer has passed the screen, as illustrated in step 214.

If the consumer does not pass the screening process for any reason, the consumer may advantageously receive prompt notice of the failure and then be presented with a series of options that may allow the consumer to select another available unit, perhaps one that is less expensive. Additionally, if the consumer does not pass the screen, the hold is preferably removed from the unit that was previously selected by the consumer in step 204.

When the consumer does pass the screen, the consumer can be requested to provide additional application information, as shown in step 218. For example, additional information may be requested in order to complete the detailed application form required by a property management company.

In step 220, the process can be completed when the consumer is presented with the terms of the lease. In addition to the lease terms, the consumer may also be presented with any addenda to the lease and also any specific rules and regulations that are particular to the unit leased or the property management company. In one embodiment, the information presented to the consumer can preferably include the specific unit that is the subject of the lease, including the address of the unit, the name and address of the property management company, and other application information that is not specifically incorporated or expressly stated in the lease.

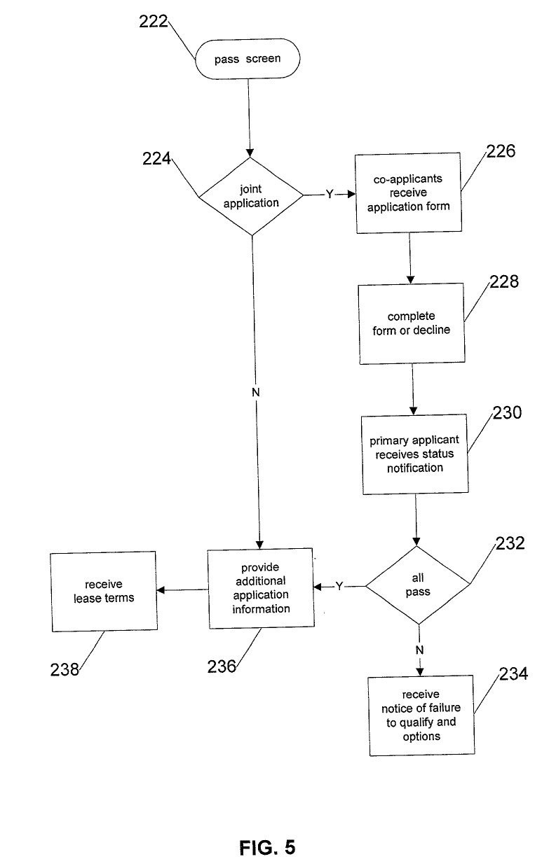

FIG. 5 is a flow chart illustrating an example process for initiating a joint application lease. The process begins with step 222, after the consumer (primary applicant) has passed the screen test. Once the primary applicant has passed, a determination is made regarding the status of the application as an individual application or a joint application, as illustrated in step 224. In the case where the application is an individual application, the process continues as previously described with reference to FIG. 4 whereby additional application information is collected (step 236) and completed lease is presented to the consumer (step 238).

In the case of joint application, each co-applicant is notified that an application form needs to be completed prior to the application being processed, as shown in step 226. In one embodiment, a co-applicant may be notified of the pending application with an electronic mail communication. Preferably, the email can include a link to a WWW based application form that the co-applicant may complete. Advantageously, the application form may be hosted on the server system and may be protected with an authorization process that requires the co-applicant to enter a username and password combination.

The co-applicant may either complete the application form or decline to be a co-applicant, as illustrated in step 228. When the co-applicant completes the application form, pre-application information may be requested for the co-applicant, including background information and financial information. Once the co-applicant has completed the application form (or declined), the primary applicant is notified of the status of the application, as seen in step 230. For example, the primary applicant may be notified via email.

In the case where the primary applicant or one of the co-applicants does not pass the screen test, as shown in step 232, the primary applicant and each of the co-applicants may be presented with a notice of the failure to qualify and a list of options. For example, the applicants may be requested to select another, less expensive unit, or they may be directed to some ancillary electronic products and services, such as credit counseling service or some other appropriate service.

When the primary applicant and each of the co-applicants pass the screen test, additional application information may be requested from each, as illustrated in step 236. In one embodiment, the request may be sent to each of the applicants with an email that contains a link to the web site that has the forms that need to be filled in prior to completion of the full application. Advantageously, each of the applicants may be required to login to the server in order to provide the additional information. This can preferably maintain the purity of the data that comprises the application. Once each of the applicants has completed and submitted the full application forms, the lease and lease terms may be presented, as shown in step 238 and previously described with reference to step 220 of FIG. 4.

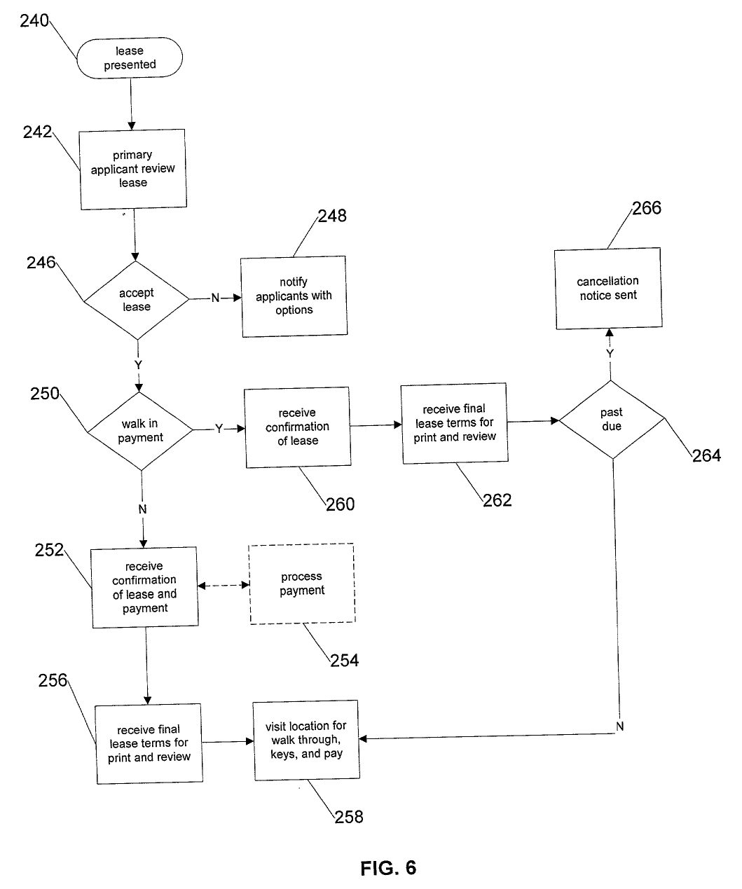

FIG. 6 is a flow chart illustrating an example process for confirming a lease and providing payment. The process begins in step 240 when a completed lease is presented to the consumer. Upon receiving the completed lease, in step 242 the consumer preferably reviews the terms of the lease, the addenda, any supplemental rules and regulations, and other information presented such as the amount of deposit required, the agreed upon rent amount, and other details. Once the consumer has reviewed the lease, the consumer can either accept or decline the lease, as shown in step 246.

If the consumer declines the lease, the server may present the consumer with a list of options in step 248 such as selecting another unit, or selecting another property location. For example, a certain property may have specific addenda to the lease or specific requirements such as no pets allowed that are not desirable to the consumer and cause the consumer to decline the lease. Alternatively, the server may offer the consumer certain ancillary e-commerce products and services.

In step 250, the consumer elects to pay the application costs through the system or in person. Advantageously, this gives the consumer the flexibility and the option to complete the leasing transaction in person. For example, the consumer may elect to bring the payment in to the leasing office and pay in cash, with a check, money order, or otherwise.

If the consumer decides to pay the application costs through the system, the consumer will receive confirmation of the lease agreement and the payment, as shown in step 252. For example, the consumer can preferably be presented with a receipt for the payment of the deposit and any other payments made through the system such as the first months rent, association fees, and the like. In one embodiment, any required payments can be processed at this time, as indicated by step 254. Additionally, the consumer can preferably receive final confirmation and approval of the lease agreement.

Once the lease has been finally approved and confirmed, in step 256 the consumer receives the final lease terms. At this time, the consumer can print a complete copy of the lease and all addenda for the consumer's records. Subsequently, the consumer can visit the property location to walk through the leased unit and pick up the keys, as shown in step 258. In one embodiment, the consumer may also pay at the time of the visit.

For example, if the consumer elected to walk in payment in step 250, then the consumer would preferably be presented with confirmation and final approval of the lease terms and addenda, as illustrated in step 260. Subsequently, the consumer receives a copy of the final and complete lease terms and all addenda that may be printed out for the consumer's records, as seen in step 262. Preferably, a time limit is established when the consumer elects to walk in payment such that the payment is delivered within a reasonable time. For example, the consumer may be given one week to provide payment. Alternatively, the consumer may be give more or less time to provide payment, depending on the circumstances and the policy of the property management company.

If the time period established for payment is exceeded and the payment becomes past due, as shown in step 264, a cancellation notice can be sent to the consumer and the hold on the unit can be released, as presented in step 266. In one embodiment, the cancellation notice can be sent by email, regular mail, or some other method, such as a telephone call to the consumer. If the payment is made within the established time period, it is preferably made at the time the consumer visits the location for a walk through in the leased unit, as illustrated in step 258. For example, when the consumer comes into the property, the consumer can pay the deposit, first months rent, and any other associated fees or deposits required. At that time, the consumer may be given keys to the leased unit and escorted over to the unit for presentation of the space.

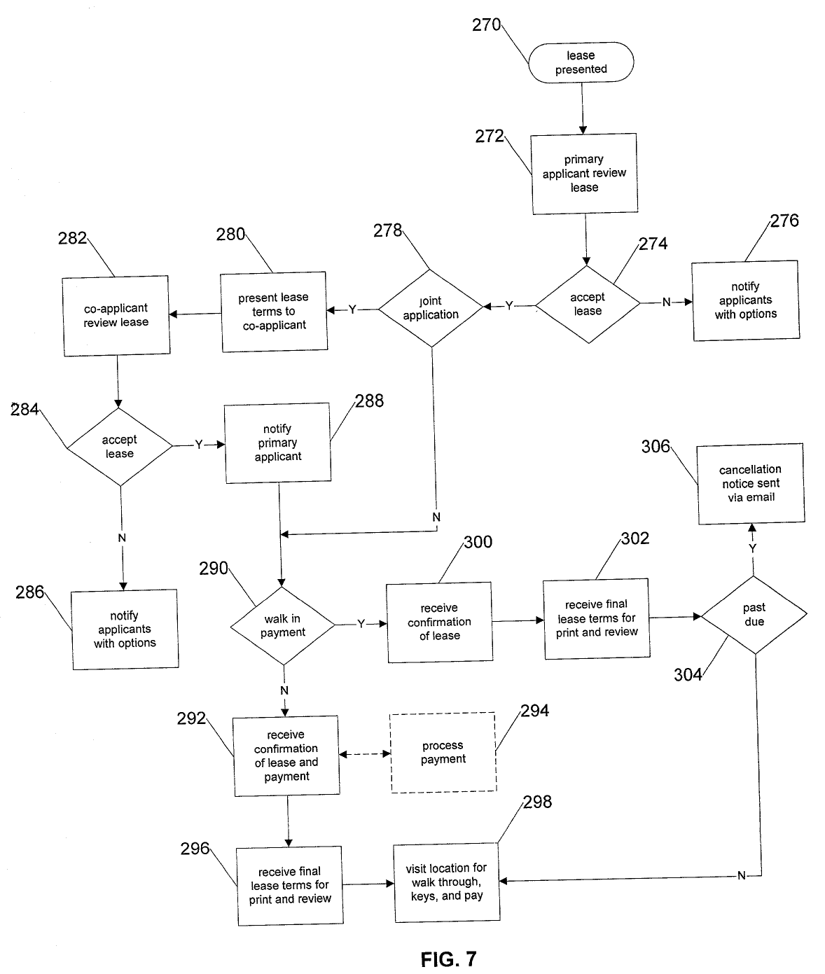

FIG. 7 is a flow chart illustrating an example process for confirming a joint application lease and providing payment. The process begins in step 270 when a completed lease is presented to the consumer (primary applicant). Upon receiving the completed lease, in step 272 the primary applicant preferably reviews the terms of the lease, the addenda, any supplemental rules and regulations, and other information presented such as the amount of deposit required, the agreed upon rent amount, and other details. Once the primary applicant has reviewed the lease, the primary applicant can either accept or decline the lease, as shown in step 274.

If the primary applicant declines the lease, the server may present the primary applicant with a list of options in step 276 such as selecting another unit, or selecting another property location. For example, a certain property may have specific addenda to the lease or specific requirements such as no pets allowed that are not desirable to the primary applicant and cause the primary applicant to decline the lease. Alternatively, the server may offer the primary applicant certain ancillary e-commerce products and services.

If the primary applicant accepts the lease in step 274, a determination is preferably made regarding the status of the application as an individual application or a joint application, as illustrated in step 278. In the case where the application is an individual application, the process continues as previously described with reference to FIG. 6, proceeding to step 290.

In the case of joint application, each co-applicant is presented with the terms of the lease so that the terms, addenda, and other components of the agreement can be reviewed, as shown in step 280. In one embodiment, a co-applicant may be notified of the lease term via an electronic mail communication. Preferably, the email can include a link to a WWW based lease form that the co-applicant may review. Advantageously, the lease form may be hosted on the server system and may be protected with an authorization process that requires the co-applicant to enter a username and password combination prior to reviewing the lease.

The co-applicant preferably reviews the lease, as illustrated in step 282, and subsequently elects to accept or decline the lease, as shown in step 284. In the case where a co-applicant declines the lease, as shown in step 284, the primary applicant and each of the co-applicants may be presented with a notice that the lease has been declined and a list of options, as illustrated in step 286. For example, the applicants may be requested to select another, less expensive unit, or they may be directed to some ancillary electronic products and services, such as credit counseling service or some other appropriate service. In one embodiment, the applicants may be prompted to continue with the lease without the co-applicant that declined the lease.

In the case where all of the co-applicants accept the lease, the primary applicant is preferably notified in step 288 so that the leasing process may be completed. For example, the primary applicant can be notified via email that the lease has been approved and requested to return to the system in order to make payment and finalize the lease. Alternatively, the primary applicant may be notified by regular mail, telephone, or fax. Preferably, the notice to the primary applicant is provided immediately after the acceptance of the lease in order to reduce the amount of time that a unit is on hold during the leasing process.

In step 290, the primary applicant (consumer) elects to pay the application costs through the system or in person. Advantageously, this gives the consumer the flexibility and the option to complete the leasing transaction online or in person. For example, the consumer may elect to bring the payment in to the leasing office and pay in cash, with a check, money order, or otherwise.

If the consumer decides to pay the application costs through the system, the consumer will receive confirmation of the lease agreement and the payment, as shown in step 292. For example, the consumer can preferably be presented with a receipt for the payment of the deposit and any other payments made through the system such as the first months rent, association fees, and the like. In one embodiment, any required payments can be processed at this time, as indicated by step 294. Additionally, the consumer can preferably receive final confirmation and approval of the lease agreement.

Once the lease has been finally approved and confirmed, in step 296 the consumer receives the final lease terms. At this time, the consumer can print a complete copy of the lease and all addenda for the consumer's records. Subsequently, the consumer can visit the property location to walk through the leased unit and pick up the keys, as shown in step 298. In one embodiment, the consumer may also pay at the time of the visit.

For example, if the consumer elected to walk in payment in step 290, then the consumer would preferably be presented with confirmation and final approval of the lease terms and addenda, as illustrated in step 300. Subsequently, the consumer receives a copy of the final and complete lease terms and all addenda that may be printed out for the consumer's records, as seen in step 302. Preferably, a time limit is established when the consumer elects to walk in payment such that the payment is delivered within a reasonable time. For example, the consumer may be given one week to provide payment. Alternatively, the consumer may be give more or less time to provide payment, depending on the circumstances and the policy of the property management company.

If the time period established for payment is exceeded and the payment becomes past due, as shown in step 304, a cancellation notice can be sent to the consumer and the hold on the unit can be released, as presented in step 306. In one embodiment, the cancellation notice can be sent by email, regular mail, or some other method, such as a telephone call to the consumer. If the payment is made within the established time period, it is preferably made at the time the consumer visits the location for a walk through in the leased unit, as illustrated in step 298. For example, when the consumer comes into the property, the consumer can pay the deposit, first months rent, and any other associated fees or deposits required. At that time, the consumer may be given keys to the leased unit and escorted over to the unit for presentation of the space.

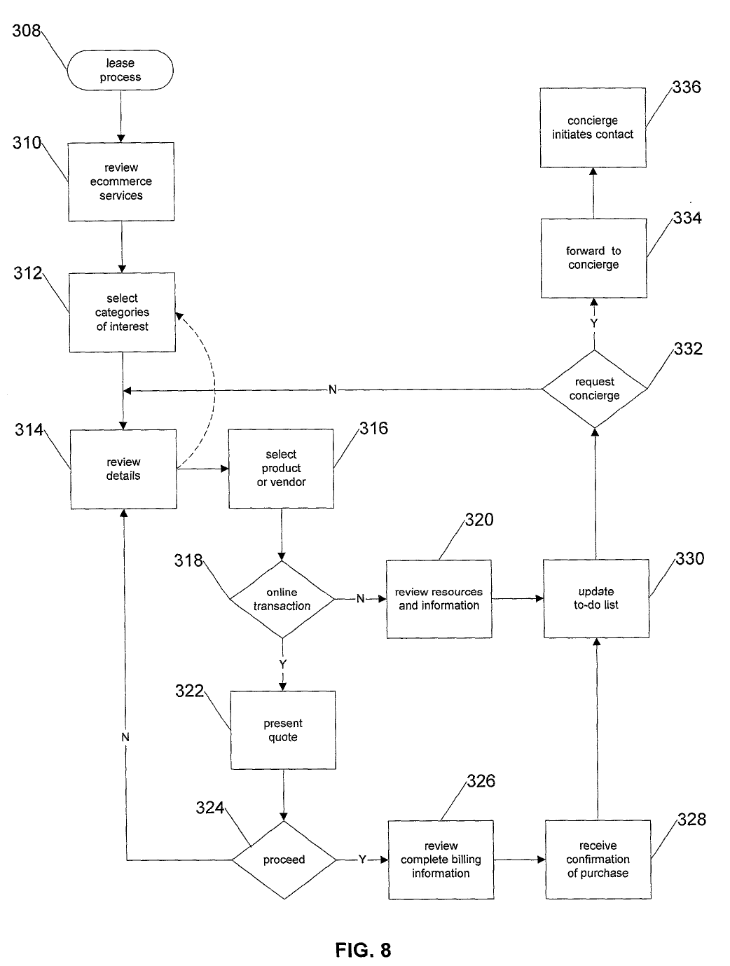

FIG. 8 is a flow chart illustrating an example process for providing ancillary commercial products and services. Advantageously, the process can begin from any point within the leasing system, as illustrated in step 308. For example, one natural point of entry to ancillary commercial products and services might be when the lease terms are denied by a consumer. Additionally, an entry point can preferably be provided after the lease terms are finalized and payment has been confirmed. This can allow a consumer to begin the process of moving once a unit has been leased. In one embodiment, the moving process can be facilitated by ancillary services such as a moving concierge.

When a consumer is presented with electronic commerce services, the consumer preferably reviews the available services to determine which services may be needed or desired, as illustrated in step 310. In one embodiment, the services presented can be tailored to the characteristics of the consumer based on information contained in the consumer's profile. Furthermore, the particular products and services that are presented can be context sensitive so that the location of the consumer in the process determines which products and services are presented. Additionally, the consumer may have the option of viewing all of the available products and services, rather than a specifically tailored list based on the user profile or context.

Once the consumer is presented with the list of productions and services, the consumer may select a particular category of desires products or services, as shown in step 312. For example, the consumer may select a desired category by selecting the category from a list, by selecting a link for the category, or by selecting a button associated with the category.

In one embodiment, the selections that the consumer chooses can be stored as a list of “to-do” items in the profile for the consumer. For example, a consumer may choose the selections for a moving company, for a change of postal address, for setting up cable TV service, for turning on utilities, and a change of DMV address. Each of these items may then be stored in the consumer's profile as a checklist of items that the consumer desires to accomplish prior to the move. Advantageously, each item in the list can be associated with the actual service such that returning to the list and selecting an item will initiate the service or a connection to the product or service.

After the consumer has selected the categories of interest, the consumer can review the details of that particular service, as illustrated in step 314. In one embodiment, the service may include several sub-services, in which case the consumer may review the categories in step 314 and select the sub-category of interest back in step 312. This process can cycle through until the granular product/service level is attained. The various details that may be reviewed in step 314 can advantageously include the offers, products, and services of the property management companies preferred providers. Additionally those products and services provided by the server system can also be prominently presented so that the consumer can comparison shop.

Once the details have been reviewed, the consumer can select the particular desired product or service, as shown in step 316. If the transaction to purchase the product or provide the service can take place online, as determined in step 318, then a quote for the product or service can be provided to the consumer in step 322. Alternatively, the consumer may be presented with information related to the product or services and directed to additional resources. For example a list of ways to complete the transaction offline may be presented to the consumer, including telephone numbers and addresses of the offline providers.

Once a quote is presented to the consumer in step 322, if the consumer agrees to the cost of the product or service, as determined in step 324, the transaction may proceed to its conclusion. In one embodiment, the consumer may be presented with complete billing information for final review and the transaction can be processed. Processing the transaction can include settlement of the billing, arranging for delivery of the purchased product, and providing additional information.

After the transaction has been processed, the consumer is preferably provided with a confirmation of the purchase. For example, a transaction record or receipt may be provided to the consumer to memorialize the transaction. Additionally, a confirmation may include ads and links to additional products and services, or other options provided by the server or third party vendor.

Upon completion of the transaction, the consumer's to-do list that is part of the consumer's profile can be updated to reflect the status of the item, as illustrated instep 330. In one embodiment, transactions that are not capable of taking place online can be updated in the consumer's profile if the consumer has received the available information on the particular product or service. Advantageously, the to-do list can accurately reflect the remaining items identified by the consumer as needing to be accomplished during the moving process.

In one embodiment, the consumer may request a concierge service to help manage the entire moving process, including any items that may be included in the consumer's to-do list. In step 332, the consumer may request such a service. If a concierge service is not requested, the consumer can preferably be returned to the previous list of available services in order to select the next product or service to help with the moving process.

When the consumer elects to engage the concierge service, a message to that effect may advantageously be sent to the concierge, as shown in step 334. For example, an email may be sent to an established moving concierge service with contact information for the consumer. Additionally, certain items on the to-do list for the consumer may be checked off or eliminated by the use of a concierge, and the use of the concierge can therefore be noted in the consumer's profile. In one embodiment, a concierge can contact the consumer after receiving notice of the consumer's desire to hire a concierge, as illustrated in step 336. This contact can be facilitated through the use of email over a network, or the concierge may contact the consumer by telephone, US mail, or facsimile. Furthermore, the concierge can preferably include a description of the available services, quotes for those services, and perhaps the options that are available to the consumer.

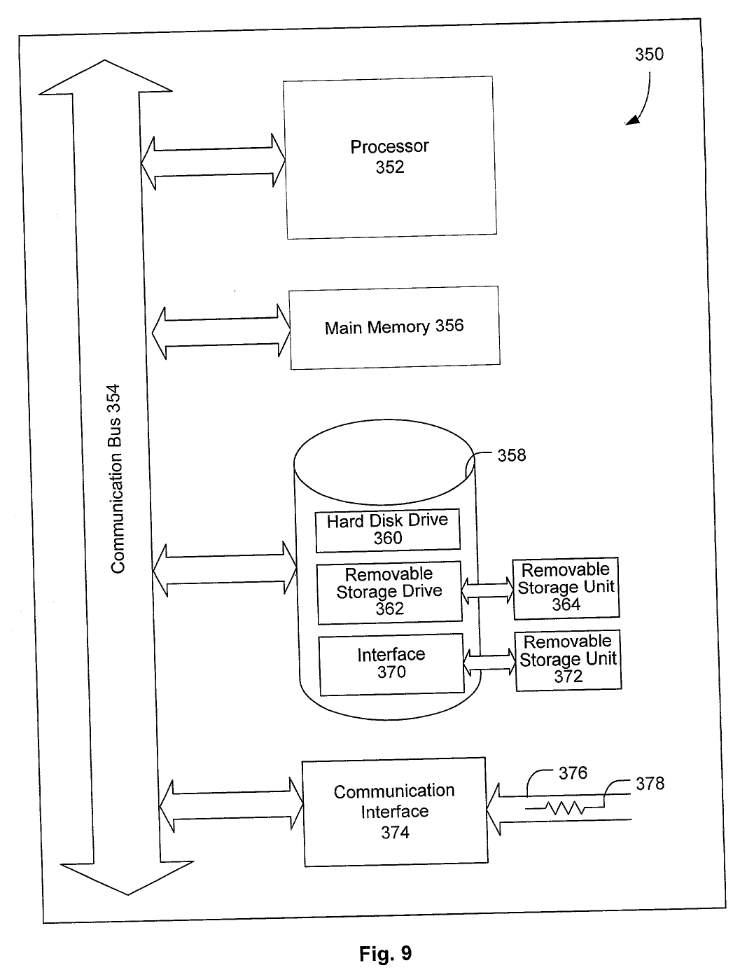

FIG. 9 is a block diagram illustrating an exemplary computer system 350 that may be used in connection with various embodiments described herein. For example, the computer system 350 may be used in conjunction with [describe various uses for a general purpose computer in relation to the invention]. However, other computer systems and/or architectures may be used, as will be clear to those skilled in the art.

The computer system 350 preferably includes one or more processors, such as processor 352. Additional processors may be provided, such as an auxiliary processor to manage input/output, an auxiliary processor to perform floating point mathematical operations, a special-purpose microprocessor having an architecture suitable for fast execution of signal processing algorithms (“digital signal processor”), a slave processor subordinate to the main processing system (“back-end processor”), an additional microprocessor or controller for dual or multiple processor systems, or a coprocessor. Such auxiliary processors may be discrete processors or may be integrated with the processor 352.

The processor 352 is preferably connected to a communication bus 354. The communication bus 354 may include a data channel for facilitating information transfer between storage and other peripheral components of the computer system 350. The communication bus 354 further may provide a set of signals used for communication with the processor 352, including a data bus, address bus, and control bus (not shown). The communication bus 354 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

Computer system 350 preferably includes a main memory 356 and may also include a secondary memory 358. The main memory 356 provides storage of instructions and data for programs executing on the processor 352. The main memory 356 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, as well as read only memory (ROM).

The secondary memory 358 may optionally include a hard disk drive 360 and/or a removable storage drive 362, for example a floppy disk drive, a magnetic tape drive, an optical disk drive, etc. The removable storage drive 362 reads from and/or writes to a removable storage unit 364 in a well-known manner. Removable storage unit 364 may be, for example, a floppy disk, magnetic tape, optical disk, etc. which is read by and/or written to by removable storage drive 362. The removable storage unit 364 includes a computer usable storage medium having stored therein computer software and/or data.

In alternative embodiments, secondary memory 358 may include other similar means for allowing computer programs or other instructions to be loaded into the computer system 350. Such means may include, for example, a removable storage unit 372 and an interface 370. Examples of secondary memory 358 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage units 372 and interfaces 370, which allow software and data to be transferred from the removable storage unit 372 to the computer system 350.

Computer system 350 may also include a communication interface 374. The communication interface 374 allows software and data to be transferred between computer system 350 and external devices, networks or information sources. Examples of some types of components that might comprise communication interface 374 include a modem, a network interface (such as an Ethernet card), a communications port, a PCMCIA slot and card, and an infrared interface, to name a few. Communication interface 374 preferably implements industry promulgated protocol standards, such as Ethernet IEEE 802 standards, Fibre Channel, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement nonstandard interface protocols as well. Software and data transferred via communication interface 374 are generally in the form of signals 378 which may be electronic, electromagnetic, optical or other signals capable of being received by communication interface 374. These signals 378 are provided to communication interface 374 via a channel 376. This channel 376 carries signals 378 and can be implemented using wire or cable, fiber optics, a phone line, a cellular phone link, a radio frequency (RF) link, or other communications channels.

Computer programming instructions (i.e., computer programs or software) are stored in the main memory 356 and/or the secondary memory 358. Computer programs can also be received via communication interface 374. Such computer programs, when executed, enable the computer system 350 to perform the features relating to the present invention as discussed herein.

In this document, the term “computer program product” is used to refer to any media used to provide programming instructions to the computer system 350. Examples of these media include removable storage units 364 and 372, a hard disk installed in hard disk drive 360, and signals 378. These computer program products are means for providing programming instructions to the computer system 350.

In an embodiment that is implemented using software, the software may be stored in a computer program product and loaded into computer system 350 using hard drive 360, removable storage drive 362, interface 370 or communication interface 374. The software, when executed by the processor 352, may cause the processor 352 to perform the features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will be apparent those skilled in the relevant art. Various embodiments may also be implemented using a combination of both hardware and software.

While the particular system and method for online leasing herein shown and described in detail is fully capable of attaining the above described objects of this invention, it is to be understood that the description and drawings represent the presently preferred embodiment of the invention and are, as such, a representative of the subject matter which is broadly contemplated by the present invention. It is further understood that the scope of the present invention fully encompasses other embodiments that may become obvious to those skilled in the art, and that the scope of the present invention is accordingly limited by nothing other than the appended claims.

What is claimed is:

1. A system for establishing a lease agreement between a first party and a second party, wherein the lease agreement is executed over a computer network, comprising:
a listing module configured to provide a list of units available for leasing;
a scoring module configured to screen an applicant;
a leasing module configured to provide a lease agreement and receive acceptance of the lease agreement; and
a payment module configured to receive payment.

2. The system of claim 1, wherein the listing module is further configured to provide a vacancy forecast for prospectively available units.

3. The system of claim 2, wherein the listing module is further configured to provide a list of fees and deposits for each available unit and for each prospectively available unit.

4. The system of claim 1, wherein the scoring module screens the applicant based on a set of demographic information provided by the applicant.

5. The system of claim 4, wherein the scoring module further performs online credit checks.

6. The system of claim 5, wherein the scoring module further performs a real-time background check.

7. The system of claim 6, wherein the scoring module further allows a single application for multiple units.

8. The system of claim 7, wherein the scoring module is further configured to accept or deny the applicant.

9. The system of claim 8, wherein the scoring module is further configured to provide unit vacancy and yield management.

10. The system of claim 1, wherein the leasing module is further configured to provide a single or joint application lease.

11. The system of claim 10, wherein the leasing module is further configured to determine the security deposit.

12. The system of claim 11, wherein the leasing module is further configured to accept an electronic signature from the applicant.

13. The system of claim 1, wherein the payment module is further configured to accept an electronic payment.

14. The system of claim 13, wherein an electronic payment comprises a credit card payment, electronic funds transfer payment, or an online check payment.

15. The system of claim 14, wherein the payment module is further configured to send periodic billing statements, process periodic payments, and keep payment records for an established lease.

16. The system of claim 1, further comprising a commerce module configured to provide electronic services and information services to the applicant.

17. The system of claim 16, wherein the electronic services comprise stock quotes, bill payments, and third party transactions.

18. The system of claim 16, wherein the information services comprise concierge service and to-do checklist reminders.

19. A method for establishing a lease agreement between a first party and a second party, wherein the lease agreement is executed over a computer network, comprising:
providing to a first party a list of units available for leasing;
receiving from the first party a request to lease a unit;
screening the first party;
compiling a lease agreement pertaining to the first party, a second party, and the requested unit;
presenting the lease agreement;
receiving from the first party approval of the lease agreement; and
receiving payment from the first party.

20. The method of claim 19, wherein the providing step further comprises:
providing a list of currently available units; and
providing a list of prospectively available units.

21. The method of claim 20, wherein the screening step further comprises:
receiving a set of demographic information;
scoring the first party based on the demographic information; and
determining the suitability of the first party based on the score.

22. The method of claim 21, wherein the receiving payment step further comprises:
receiving credit card information from the first party;
receiving payment approval from the first party;
providing the credit card information to a credit card processor; and
receiving a payment confirmation from the credit card processor.

23. The method of claim 22, further comprising the steps of:
providing a payment status based on the payment confirmation; and
presenting a payment receipt to the first party.

24. A computer readable medium having stored thereon one or more sequences of instructions for causing one or more microprocessors to perform the steps for establishing a lease agreement between a first party and a second party, wherein the lease agreement is executed over a computer network, the steps comprising:
providing a first party a list of units available for leasing, comprising:
a set of currently available units; and
a set of prospectively available units;
receiving from the first party a request to lease a unit;
receiving a set of demographic information pertaining to the first party;
scoring the first party based on the demographic information;
determining the suitability of the first party based on the score;
compiling a lease agreement pertaining to the first party, a second party, and the requested unit;
presenting the lease agreement to the first party;
receiving from the first party approval of the lease agreement;
receiving from the first party electronic payment information;
processing the electronic payment;
providing a payment status to the first party; and
presenting to the first party a payment receipt upon successful completion of the electronic payment transaction.
